(19) United States
(12) Patent Application Publication
(10) Pub. No.: US 2007/0030415 A1
(43) Pub. Date: Feb. 8, 2007

(54) Back-lit displays with high illumination uniformity

(76) Inventor: Kenneth A. Epstein, St. Paul, MN (US)

Correspondence Address: 3M INNOVATIVE PROPERTIES COMPANY, PO BOX 33427, ST. PAUL, MN, 55133-3427, US

(21) Appl. No.: 11/129,942

(22) Filed: May 16, 2005

(51) Int. Cl. G02F 1/1335

(52) U.S. Cl. 349/64

(57) ABSTRACT

A directly illuminated display unit has a light source unit that includes one or more light sources capable of producing illumination light for illuminating a display panel. A diffuser layer is disposed between the light source unit and the display panel. At least one of a first brightness enhancing layer and a reflective polarizer is disposed between the diffuser layer and the display panel. A light-diverting surface is disposed between the diffuser layer and the light source unit. The light-diverting surface diverts a propagation direction of at least some of the illumination light passing from the light source unit to the diffuser layer.

### FIELD OF THE INVENTION

The invention relates to optical displays, and more particularly to liquid crystal displays (LCDs) that are directly illuminated by light sources from behind, such as may be used in LCD monitors and LCD televisions.

### BACKGROUND

Some display systems, for example liquid crystal displays (LCDs), are illuminated from behind. Such displays find widespread application in many devices such as laptop computers, hand-held calculators, digital watches, televisions and the like. Some backlit displays include a light source that is located to the side of the display, with a light guide positioned to guide the light from the light source to the back of the display panel. Other backlit displays, for example some LCD monitors and LCD televisions (LCD-TVs), are directly illuminated from behind using a number of light sources positioned behind the display panel. This latter arrangement is increasingly common with larger displays because the light power requirements, needed to achieve a certain level of display brightness, increase with the square of the display size, whereas the available real estate for locating light sources along the side of the display only increases linearly with display size. In addition, some display applications, such as LCD-TVs, require that the display be bright enough to be viewed from a greater distance than other applications. In addition, the viewing angle requirements for LCD-TVs are generally different from those for LCD monitors and hand-held devices.

Some LCD monitors and most LCD-TVs are commonly illuminated from behind by a number of cold cathode fluorescent lamps (CCFLs). These light sources are linear and stretch across the full width of the display, with the result that the back of the display is illuminated by a series of bright stripes separated by darker regions. Such an illumination profile is not desirable, and so a diffuser plate is typically used to smooth the illumination profile at the back of the LCD device.

Currently, LCD-TV diffuser plates employ a polymeric matrix of polymethyl methacrylate (PMMA) with a variety of dispersed phases that include glass, polystyrene beads, and CaCO₃ particles. These plates often deform or warp after exposure to the elevated temperatures of the lamps. In addition, some diffusion plates are provided with a diffusion characteristic that varies spatially across its width, in an attempt to make the illumination profile at the back of the LCD panel more uniform. Such non-uniform diffusers are sometimes referred to as printed pattern diffusers. They are expensive to manufacture, and increase manufacturing costs, since the diffusing pattern must be registered to the illumination source at the time of assembly. In addition, the diffusion plates require customized extrusion compounding to distribute the diffusing particles uniformly throughout the polymer matrix, which further increases costs.

### SUMMARY OF THE INVENTION

One embodiment of the invention is directed to a directly illuminated display unit that has a light source unit comprising one or more light sources capable of producing illumination light and a display panel. A diffuser layer is disposed between the light source unit and the display panel. At least one of a first brightness enhancing layer and a reflective polarizer is disposed between the diffuser layer and the display panel. A light-diverting surface is disposed between the diffuser layer and the light source unit. The light-diverting surface diverts a propagation direction of at least some of the illumination light passing from the light source unit to the diffuser layer.

Another embodiment of the invention is directed to a method of operating a display panel. The method includes generating illumination light and directing the illumination light generally towards the display panel. The illumination light is diverted at a first structured surface. The diverted illumination light is diffused and then passed onto the display panel.

The above summary of the present invention is not intended to describe each illustrated embodiment or every implementation of the present invention. The figures and the following detailed description more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 schematically illustrates a back-lit liquid crystal display device that is capable of using a diffuser plate according to principles of the present invention;

FIG. 2A schematically illustrates a light source having a backlight and a light management unit according to principles of the present invention;

FIG. 2B presents a graph showing the luminance as a function of position across the light source of FIG. 2A, for different types of diffuser plate, where no brightness enhancing layer or reflective polarizer were used;

FIG. 2C presents a graph showing the luminance as a function of position across the light source of FIG. 2A, for different types of diffuser plate, where both a brightness enhancing layer and a reflective polarizer were used;

FIG. 2D presents a graph showing the experimentally measured variation in luminance across a backlight as a function of single-pass transmission through the diffuser layer;

FIG. 3A schematically illustrates a model light source used in model calculations;

FIG. 3B presents a graph showing the luminance as a function of position across the model light source of FIG. 3A, for various values of single pass transmission through the diffuser;

FIG. 3C presents a graph showing the variance in the illumination across the model light source as a function of single pass transmission through the diffuser;

FIG. 4A schematically illustrates a generic embodiment of a light-diverting element that may be used to divert light before entering the diffuser layer, according to principles of the present invention;

FIGS. 4B-D schematically illustrate different exemplary embodiments of light-diverting surfaces that may be used to divert light before entering the diffuser layer, according to principles of the present invention;

FIGS. 5A and 5B schematically illustrate different exemplary embodiments of light-diverting surfaces used in various numerical examples;

FIGS. 6A and 6B present polar plots showing the profile of light transmitted through a diffuser layer without and with a light-diverting surface respectively;

FIG. 7A shows the variance in the illumination across a backlight unit as a function of diffuser transmission, for various light-diverting structures;

FIG. 7B shows the variance in the illumination across a backlight unit as a function of diffuser transmission, for various light-diverting structures;

FIG. 8 schematically illustrates another exemplary embodiment of a light-diverting surface;

FIGS. 9A-9C schematically illustrate additional exemplary embodiments of light-diverting surfaces that may be used to divert light before entering the diffuser layer, according to principles of the present invention;

FIGS. 9D and 9E schematically illustrate exemplary embodiment of light diverting surfaces having different values of “wet-out”;

FIGS. 10A and 10B shows luminance and the variance in illumination across a backlight as a function of wet-out of the light-diverting surface and 10B show illuminance:

FIG. 11A schematically illustrates another exemplary embodiment of a light-diverting surface according to principles of the present invention;

FIG. 11B schematically illustrates different types of light-diverting surfaces used in various numerical examples;

FIGS. 12-14 present graphs showing variation in the uniformity of the illuminance across a backlight using a light-diverting surface of the type shown in FIG. 11B, as a function of various aspects of the surface shape, and for different depths of backlight; and

FIG. 15 shows a graph of illuminance as a function of position across an embodiment of a backlight according to principles of the present invention in comparison with simple diffuser plates.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is applicable to display panels, such as liquid crystal displays (LCDs, or LC displays), and is particularly applicable to LCDs that are directly illuminated from behind, for example as are used in LCD monitors and LCD televisions (LCD-TVs). More specifically, the invention is directed to the management of light generated by a direct-lit backlight for illuminating an LC display. An arrangement of light management films is typically positioned between the backlight and the display panel itself. The arrangement of light management films, which may be laminated together or may be free standing, typically includes a diffuser plate and a brightness enhancement film having a prismatically structured surface.

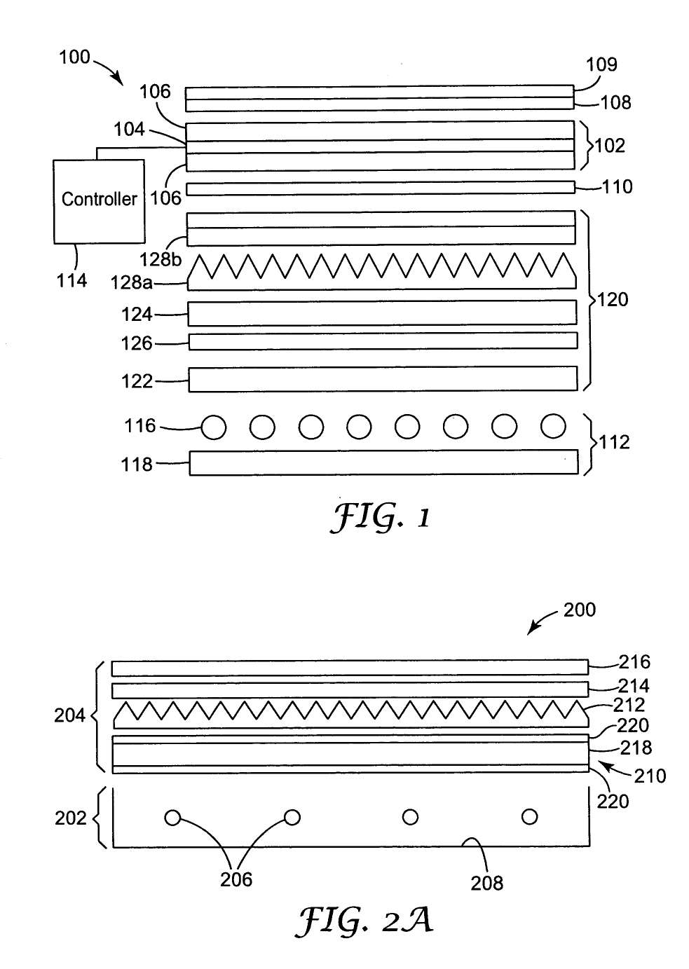

A schematic exploded view of an exemplary embodiment of a direct-lit display device 100 is presented in FIG. 1. Such a display device 100 may be used, for example, in an LCD monitor or LCD-TV. The display device 100 may be based on the use of an LC panel 102, which typically comprises a layer of LC 104 disposed between panel plates 106. The plates 106 are often formed of glass, and may include electrode structures and alignment layers on their inner surfaces for controlling the orientation of the liquid crystals in the LC layer 104. The electrode structures are commonly arranged so as to define LC panel pixels, areas of the LC layer where the orientation of the liquid crystals can be controlled independently of adjacent areas. A color filter may also be included with one or more of the plates 106 for imposing color on the image displayed.

An upper absorbing polarizer 108 is positioned above the LC layer 104 and a lower absorbing polarizer 110 is positioned below the LC layer 104. In the illustrated embodiment, the upper and lower absorbing polarizers are located outside the LC panel 102. The absorbing polarizers 108, 110 and the LC panel 102 in combination control the transmission of light from the backlight 112 through the display 100 to the viewer. For example, the absorbing polarizers 108, 110 may be arranged with their transmission axes perpendicular. In an unactivated state, a pixel of the LC layer 104 may not change the polarization of light passing therethrough. Accordingly, light that passes through the lower absorbing polarizer 110 is absorbed by the upper absorbing polarizer 108. When the pixel is activated, on the other, hand, the polarization of the light passing therethrough is rotated, so that at least some of the light that is transmitted through the lower absorbing polarizer 110 is also transmitted through the upper absorbing polarizer 108. Selective activation of the different pixels of the LC layer 104, for example by a controller 114, results in the light passing out of the display at certain desired locations, thus forming an image seen by the viewer. The controller may include, for example, a computer or a television controller that receives and displays television images. One or more optional layers 109 may be provided over the upper absorbing polarizer 108, for example to provide mechanical and/or environmental protection to the display surface. In one exemplary embodiment, the layer 109 may include a hardcoat over the absorbing polarizer 108.

It will be appreciated that some type of LC displays may operate in a manner different from that described above. For example, the absorbing polarizers may be aligned parallel and the LC panel may rotate the polarization of the light when in an unactivated state. Regardless, the basic structure of such displays remains similar to that described above.

The backlight 112 includes a number of light sources 116 that generate the light that illuminates the LC panel 102. The light sources 116 used in a LCD-TV or LCD monitor are often linear, cold cathode, fluorescent tubes that extend along the height of the display device 100. Other types of light sources may be used, however, such as filament or arc lamps, light emitting diodes (LEDs), flat fluorescent panels or external fluorescent lamps. This list of light sources is not intended to be limiting or exhaustive, but only exemplary.

The backlight 112 may also include a reflector 118 for reflecting light propagating downwards from the light sources 116, in a direction away from the LC panel 102. The reflector 118 may also be useful for recycling light within the display device 100, as is explained below. The reflector 118 may be a specular reflector or may be a diffuse reflector. One example of a specular reflector that may be used as the reflector 118 is Vikuiti™ Enhanced Specular Reflection (ESR) film available from 3M Company, St. Paul, Minn. Examples of suitable diffuse reflectors include polymers, such as PET, PC, PP, PS loaded with diffusely reflective particles, such as titanium dioxide, barium sulphate, calcium carbonate or the like. Other examples of diffuse reflectors, including microporous materials and fibril-containing materials, are discussed in co-owned U.S. Patent Application Publication 2003/0118805 A1, incorporated herein by reference.

An arrangement 120 of light management films, which may also be referred to as a light management unit, is positioned between the backlight 112 and the LC panel 102. The light management films affect the light propagating from backlight 112 so as to improve the operation of the display device 100. For example, the arrangement 120 of light management films may include a diffuser plate 122. The diffuser plate 122 is used to diffuse the light received from the light sources, which results in an increase in the uniformity of the illumination light incident on the LC panel 102. Consequently, this results in an image perceived by the viewer that is more uniformly bright.

The light management unit 120 may also include a reflective polarizer 124. The light sources 116 typically produce unpolarized light but the lower absorbing polarizer 110 only transmits a single polarization state, and so about half of the light generated by the light sources 116 is not transmitted through to the LC layer 104. The reflecting polarizer 124, however, may be used to reflect the light that would otherwise be absorbed in the lower absorbing polarizer, and so this light may be recycled by reflection between the reflecting polarizer 124 and the reflector 118. At least some of the light reflected by the reflecting polarizer 124 may be depolarized, and subsequently returned to the reflecting polarizer 124 in a polarization state that is transmitted through the reflecting polarizer 124 and the lower absorbing polarizer 110 to the LC layer 104. In this manner, the reflecting polarizer 124 may be used to increase the fraction of light emitted by the light sources 116 that reaches the LC layer 104, and so the image produced by the display device 100 is brighter.

Any suitable type of reflective polarizer may be used, for example, multilayer optical film (MOF) reflective polarizers; diffusely reflective polarizing film (DRPF), such as continuous/disperse phase polarizers, wire grid reflective polarizers or cholesteric reflective polarizers.

Both the MOF and continuous/disperse phase reflective polarizers rely on the difference in refractive index between at least two materials, usually polymeric materials, to selectively reflect light of one polarization state while transmitting light in an orthogonal polarization state. Some examples of MOF reflective polarizers are described in co-owned U.S. Pat. No. 5,882,774, incorporated herein by reference. Commercially available examples of MOF reflective polarizers include Vikuiti™ DBEF-D200 and DBEF-D440 multilayer reflective polarizers that include diffusive surfaces, available from 3M Company, St. Paul, Minn.

Examples of DRPF useful in connection with the present invention include continuous/disperse phase reflective polarizers as described in co-owned U.S. Pat. No. 5,825,543, incorporated herein by reference, and diffusely reflecting multilayer polarizers as described, e.g., in co-owned U.S. Pat. No. 5,867,316, also incorporated herein by reference. Other suitable types of DRPF are described in U.S. Pat. No. 5,751,388.

Some examples of wire grid polarizers useful in connection with the present invention include those described in U.S. Pat. No. 6,122,103. Wire grid polarizers are commercially available from, inter alia, Moxtek Inc., Orem, Utah.

Some examples of cholesteric polarizer useful in connection with the present invention include those described, for example, in U.S. Pat. No. 5,793,456, and U.S. Patent Publication No. 2002/0159019. Cholesteric polarizers are often provided along with a quarter wave retarding layer on the output side, so that the light transmitted through the cholesteric polarizer is converted to linear polarization.

A polarization control layer 126 may be provided in some exemplary embodiments, for example between the diffuser plate 122 and the reflective polarizer 124. Examples of polarization control layer 126 include a quarter wave retarding layer and a polarization rotating layer, such as a liquid crystal polarization rotating layer. A polarization control layer 126 may be used to change the polarization of light that is reflected from the reflective polarizer 124 so that an increased fraction of the recycled light is transmitted through the reflective polarizer 124.

The arrangement 120 of light management layers may also include one or more brightness enhancing layers. A brightness enhancing layer is one that includes a surface structure that redirects off-axis light in a direction closer to the axis of the display. This increases the amount of light propagating on-axis through the LC layer 104, thus increasing the brightness of the image seen by the viewer. One example is a prismatic brightness enhancing layer, which has a number of prismatic ridges that redirect the illumination light, through refraction and reflection. Examples of prismatic brightness enhancing layers that may be used in the display device include the Vikuiti™ BEFII and BEFIII family of prismatic films available from 3M Company, St. Paul, Minn., including BEFII 90/24, BEFII 90/50, BEFIIIM 90/50, and BEFIIIT.

The exemplary embodiment shows a first brightness enhancing layer 128a disposed between the reflective polarizer 124 and the LC panel 102. A prismatic brightness enhancing layer typically provides optical gain in one dimension. An optional second brightness enhancing layer 128b may also be included in the arrangement 120 of light management layers, having its prismatic structure oriented orthogonally to the prismatic structure of the first brightness enhancing layer 128a. Such a configuration provides an increase in the optical gain of the display unit in two dimensions. In other exemplary embodiments, the brightness enhancing layers 128a, 128b may be positioned between the backlight 112 and the reflective polarizer 124.

The different layers in the light management unit may be free standing. In other embodiments, two or more of the layers in the light management unit may be laminated together, for example as discussed in co-owned U.S. patent applications Ser. No. 10/966,610, incorporated herein by reference. In other exemplary embodiments, the light management unit may include two subassemblies separated by a gap, for example as described in co-owned U.S. patent application Ser. No. 10/965,937, incorporated herein by reference.

Conventionally, the bulb-to-diffuser spacing, the bulb-to-bulb spacing and the diffuser transmission are the significant factors considered in designing the display for a given value of brightness and uniformity of illumination. Generally, a strong diffuser, i.e., a diffuser that diffuses a higher fraction of the incident light, improves the uniformity, but results in reduced brightness, because the high diffusing level is accompanied by strong back diffusion.

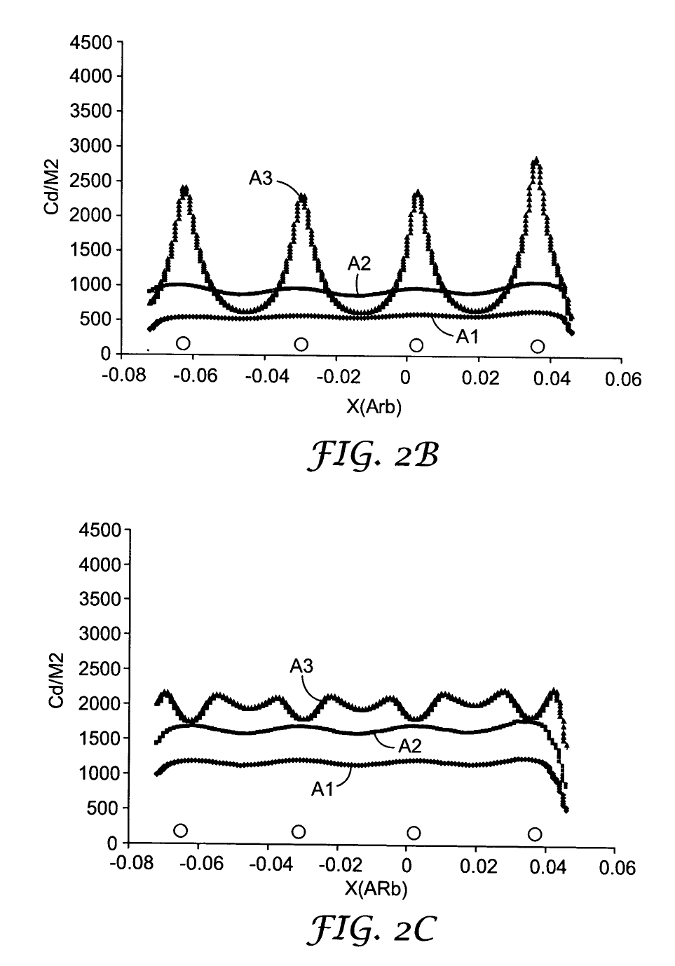

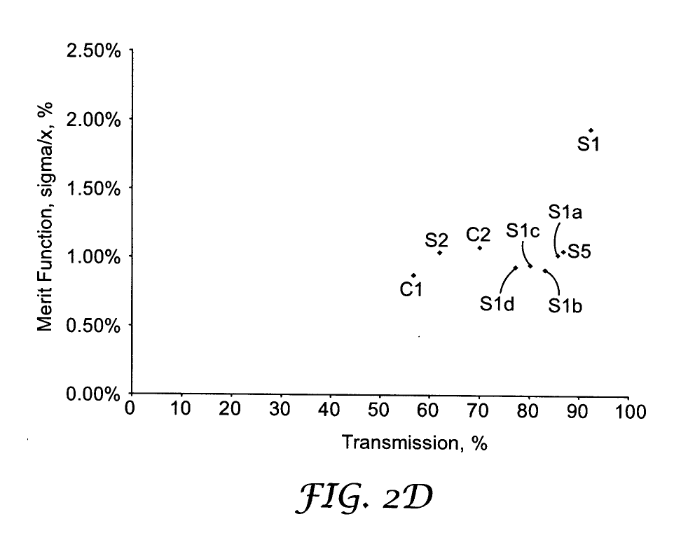

Under normal diffusion conditions, the variations in brightness seen across a screen are characterized by brightness maxima located above the light bulbs, and brightness minima located between the bulbs. This is illustrated in greater detail with reference measurements made using an experimental set up as shown in FIG. 2A. A sample light source 200, similar to what may be used for back-illuminating an LC display, was constructed with a backlight 202 and a light management unit 204. The backlight 202 included four cold cathode fluorescent lamps (CCFLs) 206, which were evenly spaced apart. The lamps 206 were positioned above a back reflector 208.

The light management unit 204 positioned above the lamps included, in order, a diffuser plate 210 and, optionally, a brightness enhancing layer 212, and a reflective polarizer 214. An absorbing polarizer 216 was positioned above the light management unit 204.

Three different examples of diffuser plate 210 were employed. Each example diffuser plate 210 had a 1 mm thick polycarbonate (PC) substrate 218, and had a diffuser layer 220 laminated to each side. In each case, the diffuser layer 220 was identical on the front and back side of the substrate 218. Characteristics of the example diffuser plates are summarized in Table I.

TABLE I
Example Diffuser Plates

| example no. | substrate type | diffuser type | single pass, T |
|---|---|---|---|
| A1 | 1 mm PC | 3635-30 | 23.4% |
| A2 | 1 mm PC | 3635-70 | 41.8% |
| A3 | 1 mm PC | 7725-314 | 86.6% |

The 3635-30, 3635-70 and 7725-314 diffusers refer to 3M™ Scotchcal™ Diffuser Film, types 3635-30 and 3635-70, and to 3M™ Scotchcal™ ElectroCut™ Graphic Film 7725-314, respectively, available from 3M Company, St. Paul, Minn. The column labeled “single pass T” lists the amount of light transmitted, T, (both specular and diffuse transmission) in a single pass through the diffuser. The different diffuser plates each absorbed only about 1%-2% of the incident light. Thus, lower single pass transmission corresponds to increased diffuse reflection.

The brightness was first measured as a function of position across the sample light source 200 with only the diffuser plate included in the light management unit 204: the light management unit 204 did not include the brightness enhancing layer 212 or the reflective polarizer 214. The measured brightness, in candelas per square meter, is shown as a function of position across the light source in FIG. 2B, for the three different diffuser plates. The A3 diffuser plate, having the highest single pass transmission, resulted in the greatest variation in brightness across the light source 200, and also provided the areas of greatest brightness. The illuminance showed significant peaks above the CCFLs 206. The A1 diffuser plate provided the lowest overall throughput but also resulted in the lowest variation in the brightness across the source 200.

The brightness across the light source 200 was also measured after the brightness enhancing layer 212 and the reflective polarizer 214 were introduced to the light management unit 204. The transmission polarization direction for the reflective polarizer 214 was aligned with the transmission polarization direction for the absorbing polarizer 216. The brightness enhancing layer 212 was a layer of 3M™ Vikuiti™ Brightness Enhancement Film III-Transparent (BEFIII-T), and the reflective polarizer 214 was a layer of 3M™ Vikuiti™ Dual Brightness Enhancement Film-Diffuse 440 (DBEF-D440), both available from 3M Company, St. Paul, Minn.

The brightness measured across the light source 200 once the light management unit 204 included the brightness enhancing layer 212 and the reflective polarizer 214 is shown in FIG. 2C, for the three different diffuser plates. Several points of interest arise in the comparison between the results of FIG. 2B and FIG. 2C. First, the average illumination across the light source 200 is higher for all three diffuser plates in FIG. 2C. This is a result of the increased efficiency when light is recycled within the light source 200 using the reflective polarizer 214 together with the reflector 208. Second, the magnitude of the variation in brightness measured when using diffuser plate A3 is significantly reduced. In FIG. 2B, the maximum to minimum variation for A3 is about 1800 Cdm⁻², whereas the maximum to minimum variation for A3 in FIG. 2C is less than about 500 Cdm⁻². Third, the relative variation in the brightness, i.e., the variation in the brightness divided by the average brightness, is less for A3 in FIG. 2C than in FIG. 2B. Thus, the addition of a brightness enhancing film reduces the magnitude of the variation in brightness.

Additionally, it is noticed that the illuminance obtained using A3 has minima located above the CCFLs 206, not maxima as seen in FIG. 2B. This behavior contrasts with that shown in the illuminance curves for A1 and A2, where there are slight maxima above the CCFLs 206. This phenomenon is discussed further below. However, it suggests that there is a value of diffuser transmission, in this example between 86.8% and 41.8%, for which the values of illuminance above the lamps changes from being a minimum to a maximum. This condition is expected to provide lower variation in the illuminance across the light source 200.

An experimental study of the relative illuminance variation, σ/x, where x is the average illuminance across the light source and σ is the standard deviation of the illuminance across the light source, reveals that there is a minimum in the relative illuminance variation for relatively high levels of single pass transmission, in the range of about 70%-85%. FIG. 2D presents a graphical summary of σ/x as a function of single pass transmission, T, through the diffuser. The details of the different diffuser layers, C1, C2, S1, S1a-d, S2 and S5, used in the study are presented in U.S. patent application Ser. No. 10/966,610. The value of σ/x is relatively low for a value of T of less than 60% (point C1). As the value of T increases, the value of σ/x initially increases and then dips to a minimum, for example, between about 70% and 90%, before rising again at values higher than 90%. Thus, there is an operating region for T that provides both high uniformity and increased throughput, since T is relatively high.

Model Light Source

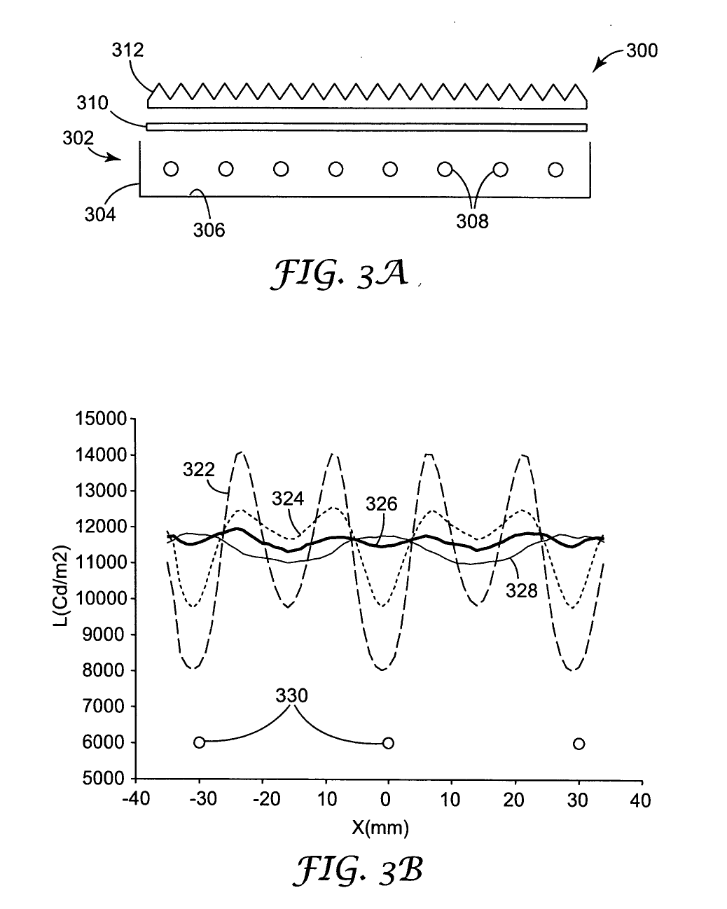

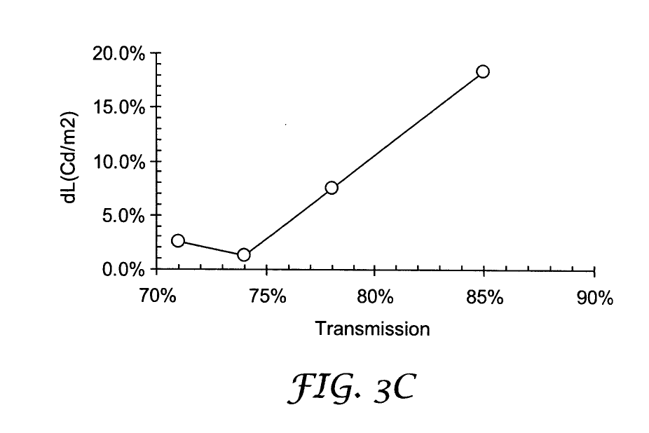

An optical ray trace model of a light source having a backlight and a light management unit was constructed to investigate the optical performance of the light source as a function of various parameters. The model light source 300, schematically illustrated in FIG. 3A comprised a reflective frame 302 that defines the edge limits of the light source array cavity 304, a diffuse reflector 306 below the array of bulbs 308, a diffuser layer 310 and a brightness enhancing layer 312 having a prismatically structured surface. The model assumed that the bulbs 308 each comprised a 20,000 nit source. A normally incident ray is traced backwards into the system from above and the sum of all the generations of daughter rays that strike a source determines the observed luminance at the surface incidence site.

Model 1

In model 1, the diffuser was assumed to have four different levels of single-pass transmission greater than 70%, namely 71%, 74%, 78% and 85%. The separation between the lamps and the back reflector 306 was taken to be 15 mm and the lamps were assumed to be placed 3 cm apart. The illuminance was calculated as a function of position across the light source 300 for various levels of single pass transmission through the diffuser layer 310: some of the results are summarized in FIG. 3B.

Curve 322, corresponding to the highest single pass transmission (85%), shows significant dips in the illuminance at positions corresponding to the positions of the lamps 330, with double-peaks at positions between the lamps 330. Curve 324, corresponding to a single pass transmission of 78%, shows qualitatively similar behavior to curve 322, except that the peaks are less pronounced. Curve 326, corresponding to a single pass transmission of 74%, is relatively flat, while curve 328, corresponding to a single pass transmission of 71% is beginning to show peaks in the illuminance above the lamps 330.

Thus, the model describes behavior qualitatively similar to the experimental results discussed above with respect to FIGS. 2B and 2C: higher levels of single pass transmission lead to reduced brightness above the light bulbs and to peaks between the light bulbs. Furthermore, a reduction in the single pass diffuser transmission leads to minima between the bulbs 308 and maxima above the bulbs 308.

The standard deviation of the level of the illuminance across the light source 300, plotted as a percent ratio of the standard deviation over the mean illuminance, is shown in FIG. 3C as a function of single pass transmission through the diffuser layer 310. For this particular example, the variation in the illuminance reaches a minimum for a transmission value of 74%. It should be noted that the transmission value, Tₘᵢₙ, where the variation is a minimum, is determined, at least in part, by some assumptions made in creating the numerical model. For example, the distance between the diffuser and the reflector below the light sources, and the prism angle of the brightness enhancing layer may both affect the specific value of Tₘᵢₙ.

Selection of the correct single pass transmission in the diffuser plate is, therefore, an important decision in designing back-lit display systems that also contain brightness enhancing films. If the transmission is lower than Tₘᵢₙ, then the illuminance variation increases and, since the recycling of light reflected from the diffuser plate is never 100% efficient, the brightness of the image may be reduced. If the transmission is higher than Tₘᵢₙ, then the illumination of the display becomes less uniform.

In conventional backlight systems, the ratio of the backlight depth and the spacing between adjacent light sources is dependent on the transmission of the diffuser layer. If the diffuser layer has a relatively high degree of reflection (low transmission), then the ratio can be made smaller, since there is a higher probability for light to be reflected and propagate across the space between light sources. If, on the other hand, the transmission is higher, then there is less chance for the light to propagate laterally, and so the ratio is made higher to allow for the light to laterally propagate. A diffuser having a higher transmission results in increased overall brightness since there is less reflection of light within the backlight, thus avoiding reflection losses. However, the need for a higher ratio of backlight depth to inter-source spacing results in either a thicker backlight or the use of more light sources. Thus, a high transmission diffuser layer is difficult to implement for conventional backlights.

According to some embodiments of the present invention, the use of a light-diverting element below the diffuser layer enables the backlight to use a higher transmission diffuser layer, which provides a high uniformity output while also maintaining a relatively thin backlight profile.

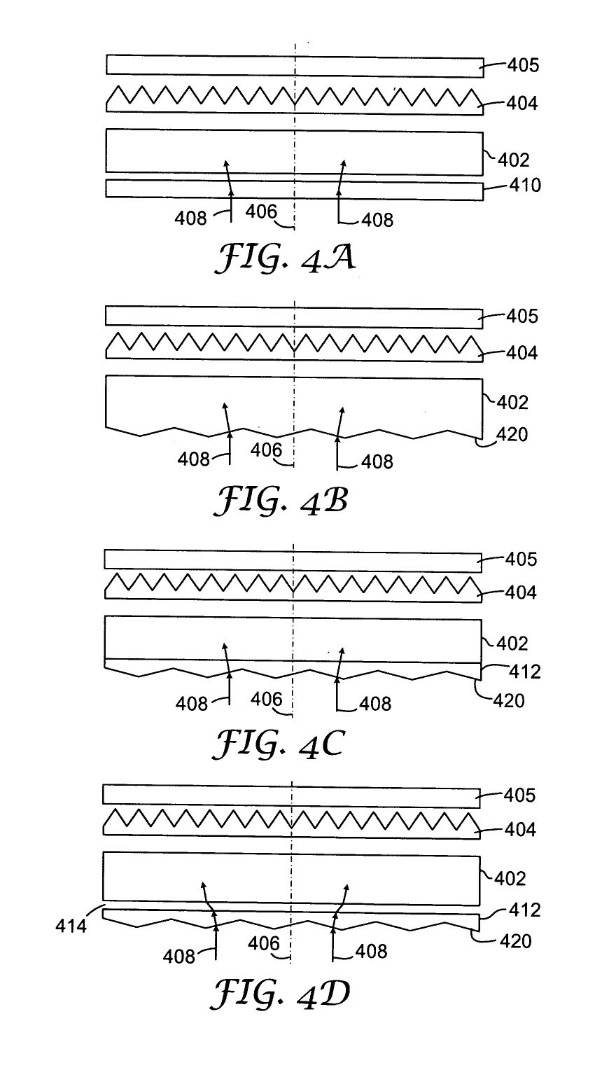

A light-diverting element, disposed between the diffuser and the light sources, may be used to increase the range of values of T over which the illuminance uniformity is high. A light-diverting element has a surface that diverts at least some of the illumination light that initially propagates in a direction parallel to an axis of the display into a direction that is non-parallel to the axis. This is schematically illustrated in FIG. 4A, which shows a diffuser layer 402. There may be a prismatic brightness enhancing layer 404 and/or a reflecting polarizer layer 405 above the diffuser layer 402. The diffuser layer 402, the brightness enhancing layer 404 and the reflecting polarizer layer 405 generally lie perpendicular to the display axis 406. Light 408, propagating from the light sources in a direction parallel to the axis 406, is diverted at a light-diverting element 410 having one or more light-diverting surfaces. A light-diverting element 410 changes the direction of the exiting light relative to the direction of the incident light. The light is diverted at one or two light-diverting surfaces of the light-diverting element. Consequently, after passing through the element 410, the light 408 propagates in a direction non-parallel to the axis 406. The light-diverting surface may be, for example, a refracting surface or a diffracting surface.

One exemplary embodiment of light-diverting surface 420 is schematically illustrated in FIG. 4B. In this embodiment, the light-diverting surface 420 is the lower surface of the diffuser 402 itself. In other embodiments, the light-diverting surface 420 may be on an intermediate layer 412, between the light sources and the diffuser layer 402, for example as shown in FIGS. 4C and 4D. The intermediate layer 412 may be attached to the diffuser layer 402, for example using an adhesive such as a pressure sensitive adhesive (PSA), as shown in FIG. 4C, or there may be a gap 414 between the intermediate layer 412 and the diffuser layer 402, as shown in FIG. 4D. The gap 414 may be filled with air or some other layer.

The light-diverting surface 420 may be structured with any suitable shape to divert the illumination light 408 in the desired manner. For example, the light-diverting surface 420 may be entirely prismatic, as illustrated in FIGS. 4A-4D, or may be partially prismatic, for example, with flat portions between the prismatic ribs.

Model 2

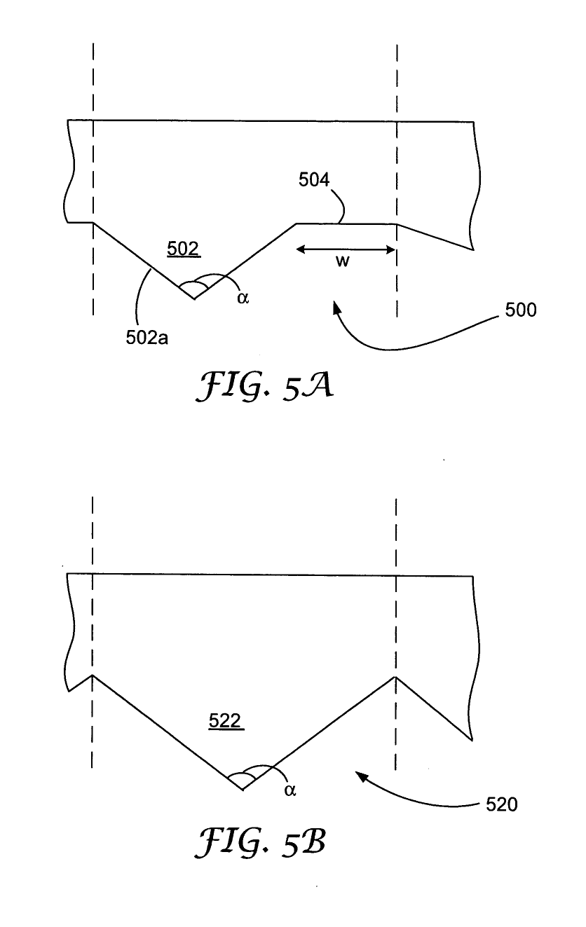

The results of some numerical calculations to explore the uniformity of illumination for different profiles of light-diverting surface are now discussed. Each light-diverting surface profile was made from a number of repeating cells, described with reference to FIGS. 5A and 5B. In FIG. 5A, the cell 500, limited by the dashed lines, had a ribbed portion 502 and a flat portion 504. The ribbed portion 502 includes surfaces 502a that are non-parallel to the diffuser layer. The ribbed portion 502 had a width equal to 70% of the cell width, and the flat portion 504 has a width, w, equal to 30% of the cell width. The ribbed portion 502 had an apex angle, α. In FIG. 5B, the cell 520, had a ribbed portion 522 whose width was equal to 100% of the cell width, i.e., there was no flat portion between ribbed portions. Seven different arrangements of light-diverting surfaces were studied: the characteristics of the different light diverting surfaces are summarized in Table I. In each case, the light-diverting surface was assumed to be the lower surface of the diffuser layer.

TABLE I
Summary of Light-Diverting Surface Characteristics

| Example No. | % Flat | Apex (°) |
|---|---|---|
| 1 | 0 | 140 |
| 2 | 30 | 140 |
| 3 | 0 | 120 |
| 4 | 30 | 120 |
| 5 | 0 | 100 |
| 6 | 30 | 100 |
| 7 | 100 | n/a |

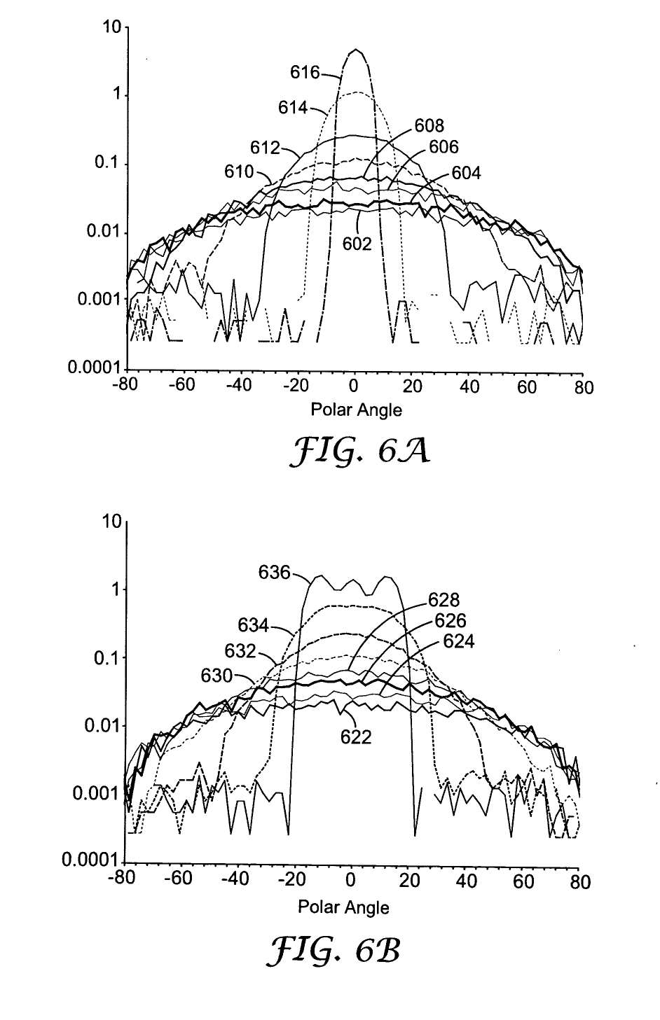

Example 7 modeled a flat surface, for comparison purposes. FIGS. 6A and 6B each show polar plots for the transmission of light through diffuser layers of various values of T. FIG. 6A shows the angle-dependent transmission for a flat surface, example 7. FIG. 6B shows the angle-dependent transmission for Example 2, with 30% of the cell flat and the ribbed portion having an apex angle of 140°. The angle is measured in a plane perpendicular to the direction of the ribs. The numbers of the curves are shown in Table II with the respective value of T.

TABLE II
Value of T for curves in FIGs. 6A and 6B

| T(%) | | |
|---|---|---|
| 50 | 602 | 622 |
| 65 | 604 | 624 |
| 70 | 606 | 626 |
| 71 | 608 | 628 |
| 75 | 610 | 630 |
| 78 | 612 | 632 |
| 85 | 614 | 634 |
| 90 | 616 | 636 |

In general, the curves in FIG. 6B, corresponding to Ex. 2, are broader than those in FIG. 6A, which leads to the conclusion that at least this type of light-diverting surface helps to make the light output more uniform.

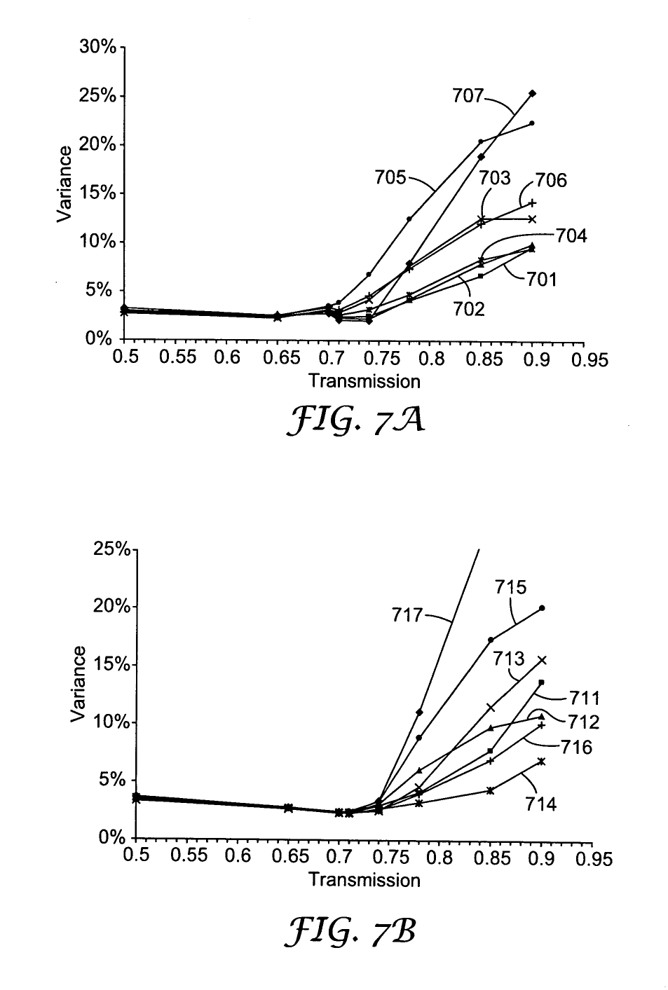

The calculated illumination variance across the backlight unit is shown in FIGS. 7A and 7B for different separations between the light sources and the back reflector. FIG. 7A presents results where the separation was assumed to be 15 mm, while FIG. 7B presents results where the separation was assumed to be 20 mm. These dimensions are referred to as the depth of the reflecting cavity. The variance was calculated for each exemplary light-diverting surface, Ex. 1-7, for each of the values of T listed in Table II. The variance is shown plotted against T. In FIG. 7A, curves 701-707 correspond to Examples 1-7 respectively. In FIG. 7B, curves 711-717 correspond to Examples 1-7 respectively.

In both FIG. 7A and FIG. 7B, there is little difference in the variance for values of transmission that are below the transmission, Tₘᵢₙ, where the variance is minimum. The differences are marked, however, for transmission values higher than Tₘᵢₙ. In FIG. 7A, two of the examples, Example 1 and Example 2 have a minimum value in the variance that is almost the same as that for the flat case, Example 7. The increase in the variance for transmission levels higher than Tₘᵢₙ is less, which means that there is more of a possibility for the designer to trade off uniformity with optical throughput.

In FIG. 7B, the difference is even more marked. In the flat case, Example 7, the variance increases quickly for values of transmission higher than that at Tₘᵢₙ. In all the structured cases, Examples 1-6, the increase in variance as a function of transmission is lower than for the flat case. The variance increases particularly slowly in Example 4, which maintains a variance of less than 5% up to a single pass transmission of about 86%.

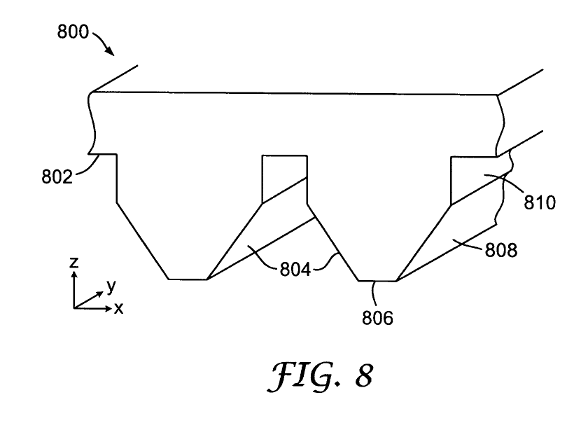

Many different types of profile may be used for the structure used in the light-diverting surface. For example, the structure may include ribs having vertical faces, perpendicular to the film. An exemplary embodiment of such a structure is schematically illustrated in FIG. 8. The film 800 is provided with a structured light-diverting surface 802 that includes ribs 804. In the illustration, the ribs 804 are shown to lie parallel to the y-axis. The ribs 804 may optionally include any combination of surfaces 806 parallel to the film 800, surfaces 808 angled with respect to the film 800, and surfaces 810 perpendicular to the film 800.

Surfaces need not be planar, but may be curved. The structure may be, but is not required to be, periodic in nature, or may be irregular.

Model 3

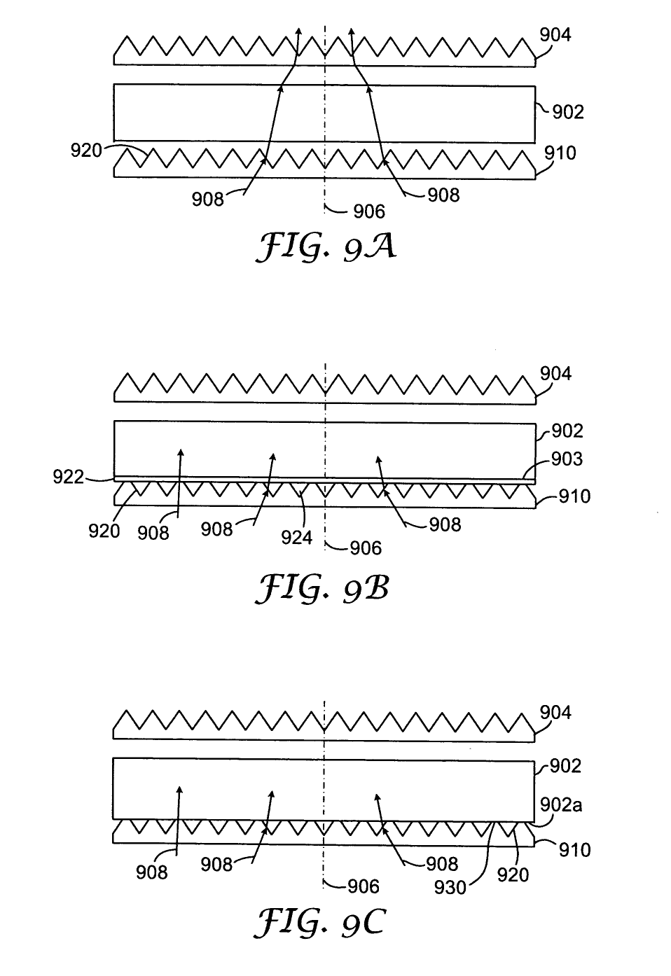

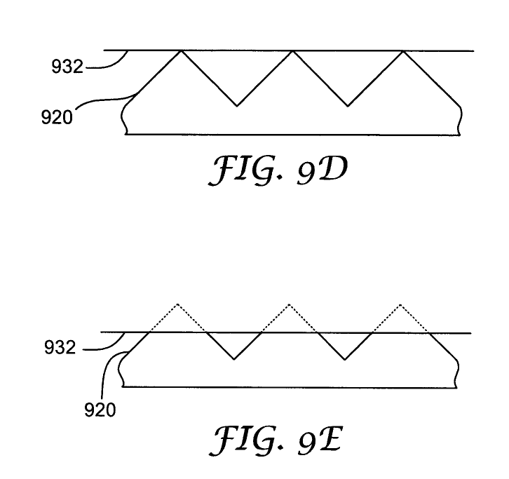

In other exemplary embodiments, the light-diverting surface may be positioned on an intermediate layer so as to face the diffuser layer. An example of this is schematically illustrated in FIG. 9A. In this example, a prismatic brightness enhancing layer 904 lies above a diffuser layer 902. In other embodiments, different types of layers, such as a reflective polarizer layer, may be positioned above the diffuser layer 902. An intermediate layer 910, which may also be referred to as a light-diverting layer, lies on the other side of the diffuser layer 902. A light-diverting surface 920 on the intermediate layer 910 faces the diffuser layer 902.

In some embodiments, the light-diverting surface 920 may be attached to the diffuser layer 902, for example, through the use of an adhesive. One exemplary embodiment of such an arrangement is schematically illustrated in FIG. 9B, in which parts of the surface 920 penetrate into an adhesive layer 922 on the lower surface 903 of the diffuser layer 902. In some embodiments, a gap 924 remains between the adhesive layer 922 and parts of the surface 920. One exemplary embodiment of a suitable light-diverting surface is an optical film with a prismatically structured surface. The attachment of such surfaces to other layers using adhesives is described in more detail in U.S. Pat. No. 6,846,089, incorporated by reference herein.

Another exemplary embodiment is schematically illustrated in FIG. 9C, in which the light-diverting surface 920 is basically prismatic, but contains portions 930 that are parallel to the lower surface 902a of the diffuser layer 902. The prismatic surface may be pressed against the lower surface 902a of the diffuser layer 902, or may be adhered to the lower surface 902a.

Numerical modeling was used to explore some of the characteristics of a backlight using the types of light-diverting surfaces illustrated in FIGS. 9B and 9C. One of the variables explored is “% wet-out”, which describes, for a prismatic type light-diverting surface, the height of the prism relative to a triangular prism having the same sized base and angle between the prism walls. This is illustrated further in FIGS. 9D-9E. In FIG. 9D, the light-diverting surface 920 comprises complete prisms positioned against the surface 932. The surface 932 may be the surface of the adhesive layer or the diffuser layer 902. In this situation, there is 0% wet-out. In FIG. 9E, the surface 932 is positioned at a location that would be at 50% of the height of the prisms if the prisms were to be fully triangular (shown in dotted lines). This situation represents 50% wet-out. A wet-out % of 100% is equivalent to the light-diverting surface being completely flat.

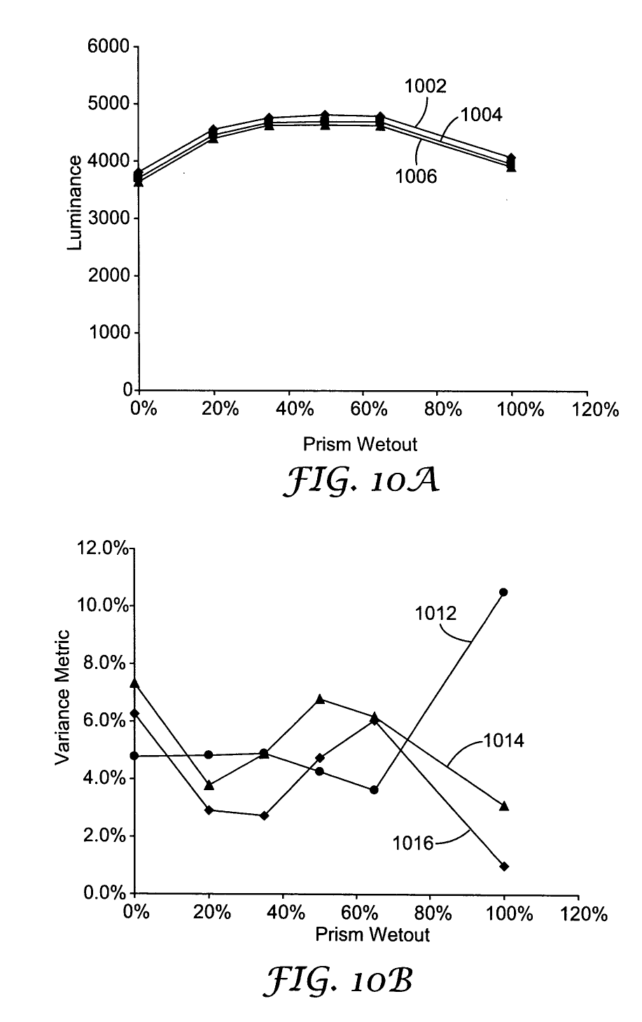

Numerical results are shown in FIG. 10A for luminance of the backlight as a function of prism wet-out for backlights having reflecting cavity depths of 10 mm, curve 1002, of 15 mm, curve 1004 and of 20 mm, curve 1006. In all three cases the luminance is calculated for a position between the diffuser layer 902 and the brightness enhancing layer 904. The calculated luminance peaks at a wet-out of about 60% for the three different cases, and there is a slight increase in brightness as the reflecting cavity becomes thinner.

Numerical results for the variance in the illumination of the backlight are presented in FIG. 10B as a function of wet-out % for the three cavity depths, 10 mm (curve 1012), 15 mm (curve 1014) and 20 mm (curve 1016). Under the particular conditions selected for the model, the minimum variation occurred in the wet-out range 20%-40% for the 15 mm and 20 mm thick backlights, and at about 65% for the 10 mm thick backlight.

Model 4

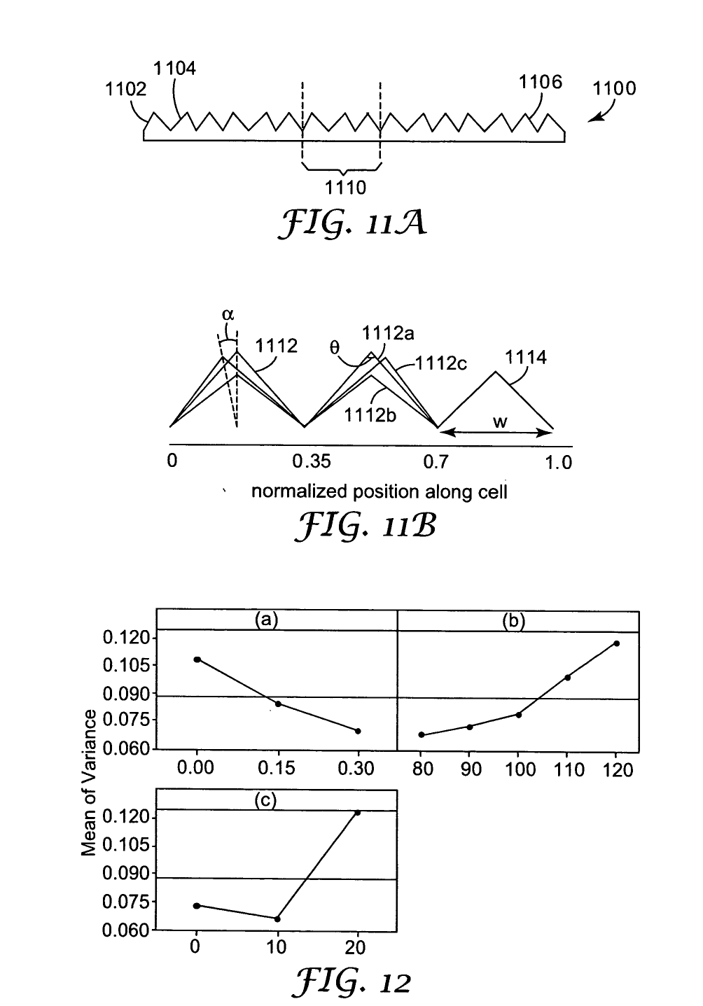

The shape of the light-diverting surface may include elements that are asymmetrical or irregular. One example of a light-diverting surface 1102 on an intermediate layer 1100 that uses asymmetric surface elements is schematically illustrated in FIG. 11A. The light-diverting surface 1102 includes asymmetric structural elements 1104 and may also include symmetric structural elements 1106. The intermediate layer 1100 that includes the light-diverting surface 1102 may be referred to as a light diverting element.

The illuminance at an image display panel that uses a backlight having a light-diverting element with asymmetric light-diverting elements has been numerically modeled. In this model, it was assumed that the light-diverting element 1100 included a “cell” 1110 of light-diverting, surface structure elements, where each cell comprised two variable prisms 1112 and an optional standard prism 1114. An example of the cell 1110 is shown in expanded form in FIG. 11B. Two characteristics of the variable prisms 1112 were varied in the study, the prism apex angle, θ, and the “canting angle”, α, i.e., that angle through which the bisector of the prism apex is rotated from being perpendicular to the element 1100. Prism 1112a has an apex angle, θ, different from the apex angle of prism 1112b, although the canting angle, α, is the same (value of zero degrees). Prisms 1112a and 1112c have the same apex angle, θ, while the canting angle is different for prisms 1112a and 1112c. When α has a value of zero, the variable prism element 1112 is symmetrical.

The value of prism apex angle, θ, was varied from 80° to 120°, and the canting angle, α, was varied from 0° to 20°. The standard prism 1114 was assumed to have an apex angle of 90°. The % width, w, of the cell that was taken up by the standard prism 1114 was varied from 0%, corresponding to the standard prism 1114 being absent, to 30% (as illustrated in FIG. 11B). The width of the cell was assumed to be 1 mm, and the separation between light sources was assumed to be 30 mm.

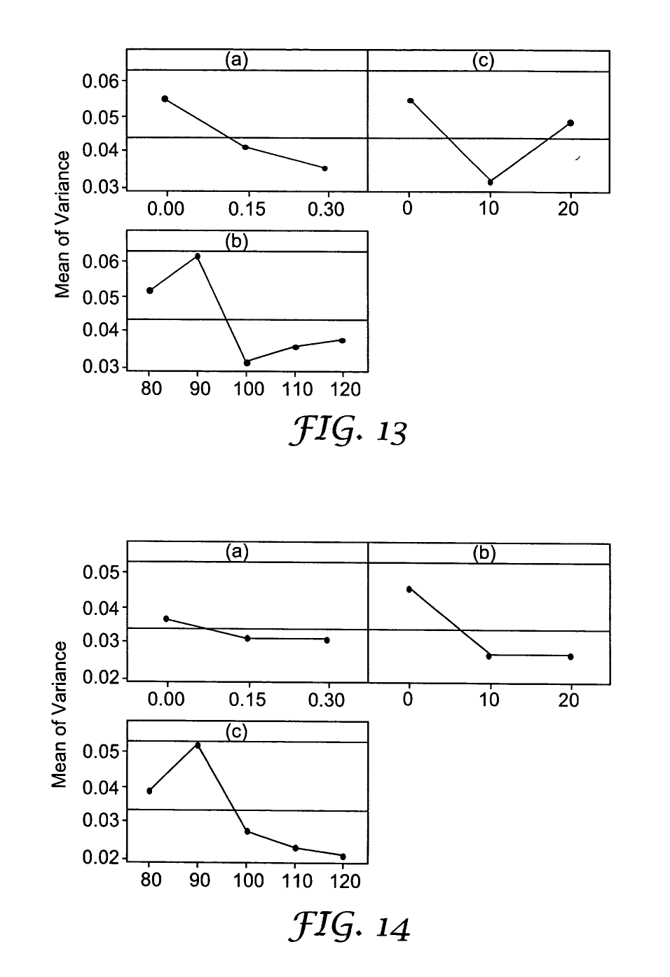

General trends in the variation in the illuminance obtained from the different modeled backlights are shown in FIG. 12 for a backlight reflecting cavity that is 10 mm deep. The data presented in FIGS. 12-14 are based on illuminance calculations for a position just above the diffuser layer 902. Graph (a) in FIG. 12 shows the variation in illuminance as a function of the % width, w, taken up by the standard prism 1114. In general, the variation in the illuminance becomes less for value of w increasing from 0% to 30%. Graph (b) shows the variation in the illuminance as a function of the apex angle, θ, of the variable prisms 1112. In general, smaller apex angles result in a reduction in the variation of the illuminance. Graph (c) shows the variation in the illuminance as a function of canting angle, α, where the two variable prisms 1112 are canted in opposite directions, +α and −α. There is a reduction in the variance for a canting angle of 10°.

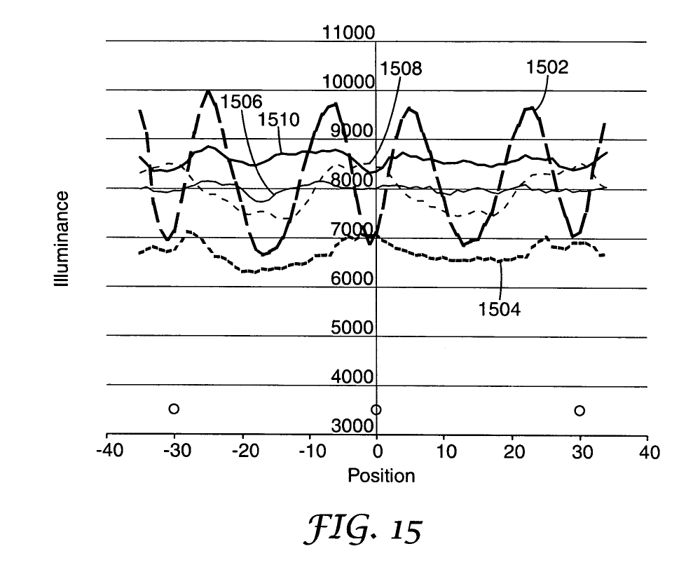

FIGS. 13 and 14 present similar data for the variation in the illuminance for backlight cavities 15 mm and 20 mm deep respectively. Both the 15 mm and 20 mm cavities show a downward trend in the variance as the value of w increases up to 30%. In the 15 mm cavity, there is a reduction in the variance for a canting angle, α, of about 10°, whereas the variance appears to flatten out for value of α of about 10° and above. Both the 15 mm and 20 mm cavities show behavior as a function of θ that is different from that of the 10 mm cavity, where the lower values of variance are obtained for value of θ in the range 100°-120°, compared to values of 80°-90°.

Model 5

Calculations have been performed to model the optical characteristics of some exemplary embodiments of backlight systems, having a 10 mm cavity depth, in which the light-diverting surface includes both wet-out and asymmetric structures. The parameters of the different surfaces, Examples 8-12, are summarized in Table III below. Examples 8 and 9 are simple diffuser layers, without a light-diverting surface.

TABLE III
Various input parameters for Model 5

| Example | α | θ | β | w | wet-out | T | Ψ |
|---|---|---|---|---|---|---|---|
| 8 | n/a | n/a | n/a | n/a | n/a | 80% | 17° |
| 9 | n/a | n/a | n/a | n/a | n/a | 55% | 82° |
| 10 | 15° | 60° | 70° | 10% | 40% | 60% | 81° |
| 11 | 0° | 120° | 110° | 50% | 20% | 70% | 47° |
| 12 | 0° | 140° | 70° | 50% | 0% | 80% | 17° |

The angles α and θ are the same as those defined in FIG. 11B, i.e. α is the “canting” angle for the asymmetric structure and θ is the apex angle for the “cantable” light-diverting structure. The angle β is the apex angle of the “symmetrical, or non-canted light-diverting structure. The length, w, is that fraction of the repeating cell on the light-diverting surface that is taken up by the symmetrical light-diverting structure. The “wet-out” parameter is the % wet-out as discussed above with regard to Model 3. The single pass transmission through the diffuser layer, T, is given in percent. The angle ψ is the half angle of diffusion, and is a function of T. The half-angle of diffusion is the angle between the light at maximum intensity and the light at half-intensity after passing through the diffuser layer. As the transmission through the diffuser layer falls, due to increased diffusion, the diffusion angle increases.

FIG. 15 shows the calculated luminance as a function of position across the backlight for the different examples. The luminance is calculated for a position above a prismatic enhancing layer 904. Table IV lists the curve number on the graph against the respective example number. Table IV also lists the average luminance, L (in nits), across the backlight, the variation (standard deviation) of the luminance, and the % variation in the luminance. The two examples, 8 and 12, with 80% diffuser transmission both produce high luminance, however example 8, which corresponds to a diffuser only, has a high variance. The variance in example 12, on the other hand, is only about 1.5%. Example 10, which uses a light-diverting surface, also has low variance but has a lower overall luminance than example 12, since the value of T for example 10 is lower than that for example 12.

TABLE IV
Calculated performance for Model 5

| example | curve | L (average) | variance | relative variance |
|---|---|---|---|---|
| 8 | 1502 | 8233 nits | 1022 nits | 12.4% |
| 9 | 1504 | 6701 nits | 212 nits | 3.2% |
| 10 | 1506 | 7999 nits | 84 nits | 1.1% |
| 11 | 1508 | 7988 nits | 393 nits | 4.9% |
| 12 | 1510 | 8575 nits | 128 nits | 1.5% |

It should be understood that light-diverting surfaces may take on many different types of shapes that are not discussed here in detail, including surfaces with light-diverting elements that are random in position, shape, and/or size. In addition, while the exemplary embodiments discussed above are directed to light-diverting surfaces that refractively divert the illumination light, other embodiments may diffract the illumination light, or may divert the illumination light through a combination of refraction and diffraction. The computational results described here show that different types and shapes of light-diverting layer provide the potential to increase illuminance, and reduce the variation in the illuminance, compared with a simple diffuser alone.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

We claim:

1. A directly illuminated display unit, comprising:
a light source unit comprising one or more light sources capable of producing illumination light;
a display panel;
a diffuser layer disposed between the light source unit and the display panel;
at least one of a first brightness enhancing layer and a reflective polarizer layer disposed between the diffuser layer and the display panel; and
a light-diverting surface disposed between the diffuser layer and the light source unit, the light-diverting surface diverting a propagation direction of at least some of the illumination light passing from the light source unit to the diffuser layer as the illumination light passes through the surface.

2. A unit as recited in claim 1, wherein the display panel comprises a liquid crystal display (LCD) panel.

3. A unit as recited in claim 1, wherein a single pass transmission through the diffuser layer is greater than about 70%.

4. A unit as recited in claim 1, wherein a single pass transmission through the diffuser layer is greater than about 74%.

5. A unit as recited in claim 1, wherein the one or more light sources comprise at least one light emitting diode.

6. A unit as recited in claim 1, wherein the one or more light sources comprise at least one fluorescent lamp.

7. A unit as recited in claim 1, wherein the diffuser layer has a lower surface facing the light source unit, the lower surface comprising the light-diverting surface.

8. A unit as recited in claim 1, further comprising an intermediate layer disposed between the diffuser layer and the light source unit, the intermediate layer comprising the light-diverting surface.

9. A unit as recited in claim 8, wherein the diffuser layer is attached to the intermediate layer.

10. A unit as recited in claim 8, wherein the light-diverting surface faces the diffuser layer.

11. A unit as recited in claim 10, further comprising an adhesive layer on a side of the diffuser layer facing the intermediate layer, portions of the light-diverting surface penetrating into the adhesive layer.

12. A unit as recited in claim 10, wherein at least some portions of the light-diverting surface are parallel to the diffuser layer and other portions of the light-diverting surface are non-parallel to the diffuser layer.

13. A unit as recited in claim 12, wherein at least some of the portions of the light-diverting surface parallel to the diffuser layer are attached to the diffuser layer.

14. A unit as recited in claim 8, wherein the light-diverting surface faces the light source unit.

15. A unit as recited in claim 1, wherein the light-diverting surface comprises a repeating structural pattern.

16. A unit as recited in claim 1, wherein the light-diverting surface comprises one or more structure portions, the one or more structure portions being regions of the light-diverting surface that are non-parallel to the diffuser layer.

17. A unit as recited in claim 16, wherein the light-diverting surface further comprises one or more flat portions parallel to the diffuser layer.

18. A unit as recited in claim 1, further comprising a second brightness enhancing layer having a prismatic structure oriented substantially orthogonal to prismatic structure of the first brightness enhancing layer.

19. A unit as recited in claim 1, further comprising a reflecting polarizer disposed between the first brightness enhancing layer and the display panel.

20. A unit as recited in claim 19, wherein the reflecting polarizer comprises a multilayer optical film.

21. A unit as recited in claim 1, further comprising a control unit coupled to the display panel to control an image displayed by the unit.

22. A method of operating a display panel, comprising:
generating illumination light;
directing the illumination light generally towards the display panel;
diverting at least some of the illumination light at a first structured surface as the illumination light passes through the structured surface;
diffusing the deviated illumination light; and
passing the diffused illumination light to the display panel.

23. A method as recited in claim 22, further comprising modulating portions of the diffused illumination light to form an image displayed by the display panel.

24. A method as recited in claim 23, further comprising controlling different modulation pixels of the display panel to modulate the illumination light.

25. A method as recited in claim 22, wherein diverting at least some of the illumination light comprises refractively diverting at least some of the illumination light at the first structured surface.

26. A method as recited in claim 22, further comprising enhancing brightness of the diffused illumination light by passing the diffused illumination light through at least one brightness enhancing film.

27. A method as recited in claim 22, further comprising reflecting diffused illumination light in a first polarization state back towards the first structured surface.

28. A method as recited in claim 27, further comprising changing the polarization state of the illumination light reflected in the first polarization state.
